(19) United States
(12) Patent Application Publication
(10) Pub. No.: US 2004/0176973 A1
(43) Pub. Date: Sep. 9, 2004

(54) Contact event log and control systems

(76) Inventors: David Lapeze, Los Angeles, CA (US); Lee Schwing, Los Angeles, CA (US); Paul L. Brindze, Los Angeles, CA (US)

Correspondence Address: ROPES & GRAY LLP, ONE INTERNATIONAL PLACE, BOSTON, MA, 02110-2624, US

(21) Appl. No.: 10/731,689

(22) Filed: Dec. 8, 2003

Related U.S. Application Data
(60) Provisional application No. 60/431,281, filed on Dec. 6, 2002.

(51) Int. Cl. G06F 17/60

(52) U.S. Cl. 705/1; 705/35

(57) ABSTRACT

A contact management and control system for managing contact events associated with an enterprise detects a contact event and actuates a contact manager to retrieve information pertaining to the contact event from a contact library. If new information is associated with the contact event, the contact library is updated with the new information. Information in the updated library is subsequently disseminated across the enterprise. A contact event has a set of identifying parameters. When a contact event is detected, the event's parameters are compared to a set of predetermined values to detect a match. If a match exists, then, in response to the contact event, a number of commands are executed according to a predetermined set of at least one rule. The contact information is updated in the contact library, and the update disseminated across the enterprise to appropriate client stations and users having privilege over the updated contact information.

### CROSS-REFERENCE TO RELATED APPLICATIONS

This application claims priority to, and asserts every other benefit of, U.S. provisional patent application having serial No. 60/431,281, filed on Dec. 6, 2002; the content of said U.S. provisional patent application is hereby incorporated by reference, in its entirety.

### BACKGROUND OF THE INVENTION

Lawyers, venture capitalists, investment bankers, and other professionals and executives depend on well managed communications with clients. In fact, in today's business world, it is not uncommon for an attorney or investment banker managing an active practice, to engage in over 100 calls per day. For all top-quality firms contact and follow up is mission critical.

Today, many professionals team with their administrative assistants to develop their own system for managing their “phone sheets.” Each administrative assistant may have his or her own unique system of codes, colors, and notations to ensure that all calls are replied to and the proper outgoing calls are placed. As well as these systems may work, problems arise during periods of personnel attrition or when an administrative assistant is absent.

Additionally, these traditional paper-based systems fail to integrate with a company's software-based client management infrastructure, fail to ensure proper delivery and tracking of a paper-based message, and fail to provide remote access (in particular, remote access to mobile phones and other wireless devices) when the intended recipient is not at his or her office. As the use of mobile phones for business communication is increasing rapidly, the ability to deliver messages quickly to such mobile professionals is becoming very important.

To address these problems, software developers have created various tools to log and manage calls. However, some packages lack the multi-user, customization and integration capabilities necessary to interact with other company applications. The packages with feature sets that can be customized to create a useful application are typically high-end CRM packages that are far too complicated for the typical user to set-up and employ. Thus, the need remains for a system that can log and manage calls in a simple and direct way.

### SUMMARY OF THE INVENTION

The systems and methods described herein implement a process that, among other things, simulates a paper-based telephone log, and extends that system into a networked application that facilitates sharing and organizing of contact events across an enterprise, including remote access via internet and from any wireless device, including a mobile phone. The design hinges, at least in part, on the principle is that each person has his or her contact event list in the system.

In one embodiment, any person in the enterprise can, with proper authorization, access any person's contact event list to add, update, or delete the list. For example, an attorney and his or her administrative assistant can jointly maintain the attorney's call list on the system. By default, when the attorney logs into the system—whether directly or remotely—he or she views his or her list of calls. The list can be filtered and/or sorted by call status, name, date created, date last modified, priority, or any combination of these and other features. If accessed remotely—for example, via a mobile phone or a phone-connected device—a single keystroke or pressing of a button can initiate a call-back based on the record. Optionally, when a user logs in to manage a call list belonging to another person—for example, when a secretary logs in to manage an attorney's call list—the user has the option to use the list owner's view of the call list or to create a customized view that may be distinct from the list owner's view in at least one aspect.

In one embodiment, the systems and methods described herein can distribute updates to, and reconcile data changes among, a plurality of data servers and client devices across an enterprise. By default, when an authorized user logs into the system from any client device having proper security and/or access credentials to execute a software application, all modification is made to the user's primary data set. The systems and methods described herein provide the means to move those changes from the primary data set to a plurality of remote data sets.

In one embodiment, the remote data set may reside on a network server, located in another office, that is connected—by means of a local area network (such as an Ethernet)—to the server maintaining the primary data set. In one embodiment, the remote data set may reside on a server that is connected—by means of a wide area network (such as an X.25 network)—to the server maintaining the primary data set. In this embodiment, a database server (such as a Microsoft SQL Server) may be used to provide clients access to the primary data set; alternatively, or additionally, a server adapted for remote serving (such as an IBM Universal Database) may be used to provide a client device access to an associated data set across a data network.

In one embodiment, a remote data set may reside on a Personal Digital Assistant (PDA), a Microsoft Pocket PC, or a laptop computer that is connected—by means of a virtual private network (VPN), a wireless network, or both—to the server maintaining the primary data set. Additionally, in this embodiment, a connection between a remote data set and a primary data set may be established according to a predetermined schedule so that data changes may be reconciled.

If an enterprise implements remote data sets, the application includes intrinsic methods and processes that allow users to access and manipulate the same entries on the different data sets. In one embodiment, an executive's assistant could be answering calls and entering data for the executive. Simultaneously, the executive could be accessing those records on a mobile device (such as a Research In Motion 957 or a Research In Motion Personal Digital Assistant (RIM PDA)) via a wireless network (such as a Mobitex), updating each record created by the assistant.

If the RIM PDA or other device is capable of initiating calls, then a one-button return-call feature could be used to return the call, update the data set, or both. If the RIM PDA or other mobile device hosting a remote data set loses contact with the primary data set, the assistant and the executive may continue to manipulate data with the application running on each of their respective accessible data sets. When connectivity is re-established between the remote data set and the primary data set, the intrinsic methods and processes of the application, well known to those of ordinary skill in the art, can reconcile the differences in the two data sets, updating each data set appropriately.

In one embodiment, the invention is realized as a software application integrated with both an individual's contact list system and an enterprise's centralized contact management system. The centralized contact manager typically maintains phone numbers and email addresses for the enterprise, or a significant part thereof.

The contact manager can store basic contact information for the enterprise's contacts and may have an interface for searching and maintaining the contact information. In one embodiment, the interface of the individual contact list system or the contact manager is configured to serve as an entry screen into the contact manager application. Rather than have users type in call information, a link is provided from the centralized contact manager interface or search screen that allows the users to create and/or modify phone log entries. An example of the application flow is when a client calls into the office; the first thing an administrative assistant does is find the client's name in an individual contact list system or the enterprise's contact manager. This process can be performed with as few as a couple of keystrokes. Once the contact information is displayed on the system, the administrative assistant can either connect the call or take a message. Depending on the call action, the administrative assistant can actuate the link on the caller's contact record to create a new phone log entry and enter the details of the call transaction. Once the transaction is saved to the database, the attorney, to whom the call was addressed, can view the new call record on his or her computer, mobile phone, or other wireless device, once his or her call list is refreshed and updated.

Each contact record can include a series of text, codes, and flags that can be set through radio buttons, or comparable input methods, on the user interface. One set of codes used in the contact manager application may be similar to an attorney's paper phone logs. The contact records may be searched and organized by the attorney, thereby providing a more powerful tool for responding to calls.

In one embodiment, a contact record—including, for example, text, codes, and flags—may be monitored by server-based processes that can manipulate the contact record, based on a set of at least one parameter designated by an authorized user; the authorized user could be an individual at whom the contact event (such as a telephone call) was addressed and to whom the contact record belongs, a user (such as an administrative assistant) designated by that individual to manipulated the contact record, or a system administrator.

The parameter set may include values found in the text, codes, flags, or any combination thereof. The systems and methods described herein may further include intrinsic server-based processes that monitor a contact event's parameter set for a match to a predetermined set of at least one designated parameter; if a match is detected, the server-based processes execute one or more commands—according to at least one predetermined rule—to manipulate at least one of contact records, data within the system, systems associated with the enterprise, and any combination thereof. Examples of possible actions in the server-based processes would be to assign the contact event (for example, a telephone call) to another person in the enterprise, or to respond to the call record through a voice response unit (VRU), or to spawn processes within other systems of the enterprise, such as an accounting or inventory system.

### BRIEF DESCRIPTION OF THE DRAWINGS

The foregoing and other objects and advantages of the invention will be appreciated more fully from the following further description thereof, with reference to the accompanying drawings, wherein;

FIG. 1 depicts schematically the structure of one system according to the invention;

FIGS. 2-6 depict screenshots of one embodiment and process for tracking and logging contact events; and

FIG. 7 is a flowchart depicting an embodiment of one method of managing contact events according to the invention.

### DEFINITIONS

For convenience, certain terms employed in the specification, including examples and appended claims, are collected here. Unless defined otherwise, all technical terms used herein have the same meaning as commonly understood by one of ordinary skill in the art to which the systems and methods described herein pertain.

The article “a” and “an” are used herein to refer to one, or to more than one (i.e., to at least one) of the grammatical object of the article, unless context clearly indicates otherwise. By way of example, “an element” means one element or more than one element.

The term “including” is used herein to mean, and is used interchangeably with, the phrase “including, but not limited to.”

The terms “comprise” and “include,” and their parallel derivative grammatical constructs (e.g., comprising and including), are used herein interchangeably, and are intended to be identical in meaning.

The term “or” is used herein to mean, and is used interchangeably with, the term “and/or,” unless context clearly indicates otherwise.

Described herein are systems and methods that manage contact events associated with an enterprise. A contact event is an event by which a first party attempts to communicatively engage with a second party by initiating a communication transaction with the second party. For example, a contact event may be a telephone call, a fax transmission, a pager message, an electronic mail (e-mail) message, an SMS (short message service) message, an MMS (Multimedia Messaging Service) message, an image communication, a sound communication, an office visit, a paper-based communication, or, in general, any event, or combination of events, initiated by the first party soliciting a response from the second party.

A contact event is said to be associated with an enterprise if either the first party initiating the contact event or the second party at the receiving end of the contact event is affiliated with the enterprise; also, it may be that both parties are affiliated with the enterprise, in which case the contact event is again said to be affiliated with the enterprise. A party who is an employee of the enterprise, an individual who is on the board of trustees of the enterprise, a member of the executive committee managing the daily affairs of the enterprise, and any group of such parties are affiliates of the enterprise.

The enterprise could be a law firm; a research center; a non-profit organization; an institution of higher learning; a corporation, including, for example, a limited liability corporation (LLC); a partnership, including, for example, a limited liability partnership (LLP); a governmental entity; a financial institution; or any organization having a number of affiliates needing proper management of their daily communications.

The term “management” (as well as its variants), at least when used to describe manipulation of contact event information, includes, but is not limited to, logging, moving, creating, editing, updating, and deleting contact event information associated with the enterprise, or any combination of these. Furthermore, according to the systems and methods described herein, managing contact events or contact information includes controlling any number of predetermined responses (i.e., executing any number of processes) upon detection of a contact event. Therefore, a contact manager detects, logs, manipulates, and launches processes based on a contact event. Management of a contact event can also include reconciling contact information across any number of servers and client stations associated with the enterprise. This can be done, for example, by disseminating, i.e., transporting, contact information among any number of the client stations and servers handling contact events or hosting contact information, and may be accomplished through a wired or wireless data network.

A response to a contact event can include any number of predetermined commands, wherein a command can be any process launched or executed by the contact management system.

The term “user” herein refers, at least in part, to any subset of an enterprise's associates who could potentially initiate or receive a contact event. Therefore, a user can be an individual or a group of individuals.

The systems described herein include a primary server responsible for maintaining a primary copy of the contact information associated with the enterprise. The primary copy is herein referred to as a primary contact library, or a close variant of the same.

To provide an overall understanding of the invention, certain illustrative practices and embodiments are described herein. However, it will be understood by one of ordinary skill in the art that the systems and methods described herein can be adapted, modified, and employed in other applications, and that such other additions, modifications, and uses will not depart from the scope hereof.

### DETAILED DESCRIPTION OF THE ILLUSTRATED EMBODIMENTS

For clarity, the following description focuses on systems that manage telephone calls; however, it will be understood by one of ordinary skill in the art that the systems and methods described herein may be adapted and modified for other suitable applications, and that such adaptations and modifications do not depart from the scope hereof.

For example, in alternate embodiments, the systems and methods described herein may log and organize e-mail contacts, letter contacts, instant messages, pager contacts, in-person office visits, and any combination thereof.

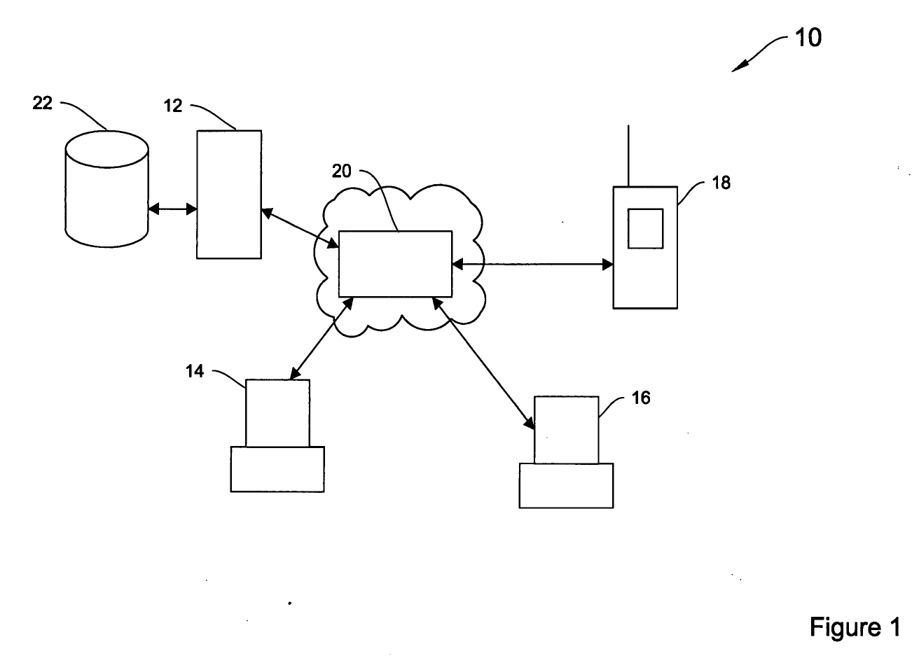

Turning now to the figures, one particular embodiment of the invention is depicted that provides for managing (including logging) of telephone contact events. More particularly, FIG. 1 depicts one embodiment of a system 10 according to the invention, for logging and managing contact events.

In the embodiment depicted by FIG. 1, a system 10 comprises a server 12 and a plurality of client stations 14, 16, and 18, connected through a network 20 to the server 12. The server 12 connects to a database 22. As will be seen from the following description, the elements of the system 10 can include commercially available devices, arranged and adapted to act as a system for managing contact events.

Alternatively, the system 10 may comprise a proprietary system, such as an embedded processing system that implements the contact event management processes described herein. Optionally, such an embedded system may be included into a private branch exchange (PBX) system, a voicemail system, or a mail server, to extend the functionality of that device.

For the depicted system 10, the client station 14, 16, or 18 can be any suitable data processing and/or storage system, such as a PC workstation, a handheld computing device, a tablet computer, a mobile phone or other wireless communication device, or any other device equipped with a network client capable of accessing the server 12 and interacting with the server 12 to exchange information.

In one embodiment, the network client includes a world wide web (WWW) client, such as a Netscape web client, a Microsoft Internet Explorer, a Lynx web client, a Mozilla web client, or any other web client; the web client may allow the user to exchange data with a web server, an ftp server, a gopher server, a mail server, or some other type of network server. The server 12 and the client stations 14, 16, and 18 can communicate across any suitable data network, such as a local-area network (LAN), a wide-area network (WAN), a wireless or cellular network, or the Internet.

Optionally, a client and a server may rely on an unsecured communication path to exchange data. To add security to such a communication path, the client and the server can employ a security system, such as any of the conventional security systems developed to provide to a remote user a secure channel for exchanging data over the Internet. One such system is the secure sockets layer (SSL), a security mechanism that provides a trusted path—intended to substantially preserve the privacy and integrity of exchanged data—between a web client (such as a browser) and a web server. An example of a web server is the Apache Hypertext Transfer Protocol (HTTP) Server.

In an embodiment, a security system may also be employed to establish a connection between a mail client (such as Netscape Mail, Microsoft Outlook, Mozilla Thunderbird, or any other mail client) and a mail server, such as an Internet Message Access Protocol (IMAP) server or Post Office Protocol (POP) server.

Therefore, optionally, any subset of the client stations 14, 16, and 18 may conduct a secure data transaction with the server 12, using a 40-bit or 128-bit encryption scheme, or any other encryption protocol supported by current technology. Other security systems can be employed, such as those described in Applied Cryptography by Bruce Schneir (Addison-Wesley, 1996). An alternative embodiment may employ, at least in part, a secure communication path, such as a dedicated phone line, for conducting a data transaction between a server and a client.

For illustrative purposes, however, the systems described herein, including system 10 depicted in FIG. 1, will be understood to employ a public channel to connect a client station to a server. The public channel may include any suitable connection, such as an Internet connection through an internet service provider (ISP) or a connection through a cellular or other wireless network—including, without limitation, those utilizing Mobitex, GSM (Global System for Mobile Communications), EDGE (Enhanced Data for GSM Evolution), GPRS (General Packet Radio Services), 3GSM (third generation GSM), CDMA (Code Division Multiple Access), CDMA 2000, iDEN (Integrated Digital Enhanced Network), UMTS (Universal Mobile Telecommunications System), 802.11, IR (infrared), and microwave technologies, a combination of these, or any other suitable connection.

In a preferred embodiment, the system 10 is a web-based contact event management and control application that allows a user to access the application through one or more URL links via a web application—such as an Outlook Public Folder URL link, or optionally a shortcut through an enterprise's web portal. Depending on how a user structures his or her workspace, he or she can access the application as part of his or her normal workflow. Thus, a user can access the contact event management and control application through Outlook, through a “stand alone” version of the application, or optionally through a mobile phone or another wireless device. In an embodiment utilizing a mobile phone interface or a device connected via wire or wirelessly to a phone, the system can allow for replying to a contact event (such as a telephone call) with single- or multiple-click actuation or via one or more voice commands.

In this web-centric embodiment, the depicted system 10 may employ a web server to exchange data between a client and the server 12. In such an embodiment, the system 10 may comprise a user interface written using a web-centric IDE (integrated digital environment), such as Microsoft's Visual Interdev. As will be known to those of ordinary skill in the art, Visual Interdev is a project management software for web application development. It integrates tools for web development; it supports server-side scripts, such as ASP (active server pages), to dynamically generate web pages in real-time (an ASP script can be programmed in JScript or VBScript, for example); it facilitates database integration; and it provides visual design tools, templates, and wizards to help perform tasks such as generating SQL (Structured Query Language) commands to communicate with a database.

Data for the contact event management and control application can reside on a database server, such as Microsoft's SQL Server, that may be executing on the server platform 12. In this embodiment, the application is two-tiered and may generate SQL calls to the database from an ASP script. As is known to those of ordinary skill in the art, an ASP script may be a code in a file that contains a combination of HTML, scripting code, and calls to executable components. A change in the ASP file accessed by the web server is automatically compiled on execution. This is achieved as ASP code processing technology is embedded into certain web servers, such as the Microsoft Web servers, and is supported on Windows NT Internet Information Server (IIS), Windows NT Workstation, and Windows 95 Personal Web Server. However, ASP is merely one way to implement the system depicted in FIG. 1; other technologies, such as cold fusion, PHP (recursive acronym for Hypertext Preprocessor), PERL (a general-purpose programming language), Python and server extension modules, may be employed, with the selection of technology being driven by the application at hand.

Optionally, the system may employ client-side processing, if data requests are small and there is the option to limit the scope of data solicited and/or retrieved by a user, thereby providing acceptable performance. In other embodiments, the data calls can be made at the server side, and the HTML can be converted to XSL (Extensible Stylesheet Language) and/or server-side XML (extensible markup language). Additionally, in an embodiment intended for access over a mobile phone network, text-to-voice and IVR (interactive voice response) techniques, well known to those of ordinary skill in the art, may be used to facilitate audio retrieval of a message, voice-command initiated return calling, or voice-command updating of a contact record.

In certain other optional embodiments, the contact event control application may leverage and integrate with a centralized contact manager operating in a read-only mode. Thus, it will be understood to those of ordinary skill in the art that one advantage of the systems described herein is that it is possible to easily integrate the contact event management and control application with any number of off-the-shelf contact management packages, such as ACT!, Goldmine, or others. It is also possible to have the contact event management and control application read customer/client data from a larger CRM (Customer Relationship Management) package such as Onyx, Great Plains, Oracle, or others.

The design and development of the web-centric contact event management and control application described above follows from principles known in the art of computer and network programming, including, for example, those set forth in Programming PERL, by Wall et al. (O'Reilly & Associates, 1996); Linux Application Development, by Johnson et al (Addison-Wesley, 1998); and The Design of the Unix Operating System, by Bach (Prentice-Hall, 1986).

The server 12 may be supported by a commercially available server platform, such as a Sun SPARC™ system running a version of the UNIX operating system and running a server capable of connecting to, or exchanging data with, a user. In the embodiment of FIG. 1, the server 12 includes a web server, such as the Apache web server or any suitable web server. The web server component of the server 12 acts to listen for requests from a client station 14, 16, or 18, and in response to such a request, resolves the request to identify a filename or script, or create dynamically-generated data that can be associated with that request and returned to the requesting client station. The operation of the web server component of server 12 can be understood more fully from Apache: The Definitive Guide, by Laurie et al. (O'Reilly & Associates, 1997).

The server 12 may also include components that extend its operation to accomplish the contact event management and control processes described herein. The architecture of the server 12 may vary according to the application. For example, the web server may have built-in extensions, typically referred to as modules, to allow the server 12 to perform operations that facilitate the contact event management and control transactions desired by a user or designed into the system, or the web server may have access to a directory of executable files employed for performing the operations, or parts of the operations, that implement the services requested by a user. Thus, it will be understood by one of ordinary skill in the art that the server 12 may act as a contact event management and control server that configures the workstation hardware supporting the server 12 to act as a system according to the invention.

The server 12 may couple to a database 22 that stores information representative of a user's account, including information representative of the user's contact list or rolodex, as well as user-defined preferences, such as instructions on how to treat a contact event. Additionally, the database 22 can store information regarding a user's account, including one or more passwords, security authorizations, access privileges, preference profiles, and similar information. The depicted database 22 can be local or distributed, and may comprise any suitable database system, including, for example, the commercially available Microsoft Access database.

The design and development of database systems suitable for use with the system 10 follow from principles known in the art, such as those described in Guide To Sybase and SQL Server, McGoveran et al. (Addison-Wesley, 1993).

The database 22 can be supported by any suitable persistent data memory, such as a hard disk drive, a RAID (Redundant Arrays of Inexpensive Disks) system, tape drive system, floppy diskette, or any other suitable system. The system 10 depicted in FIG. 1 includes a database device 22 that is separate from the server station platform 12; however, it will be understood by those of ordinary skill in the art that in other embodiments the database device 22 can be integrated into the server 12.

In other further embodiments, an interface is provided to create and maintain the user information. In a Windows 2000 environment, for example, a user may be authenticated against the Active Directory; user options can be read from a user control table supporting other in-house custom applications. However, other authentication and security systems, such as the Kerberos System, may be employed, and the system chosen will depend upon the application at hand.

### Operation of Contact Event Logging and Management System

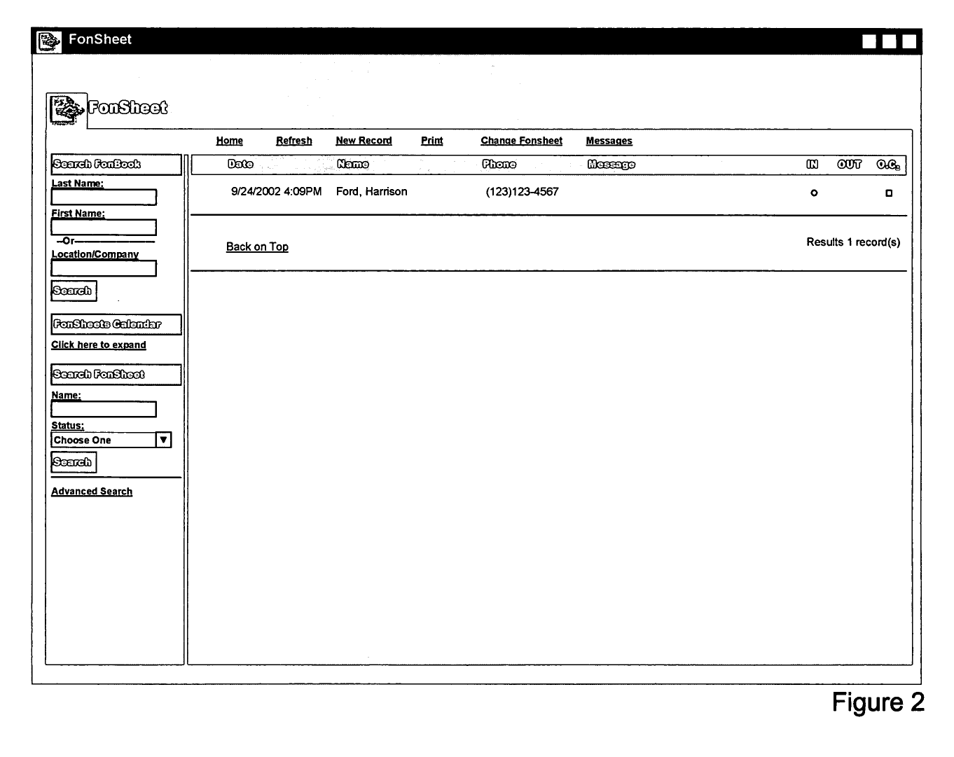

Turning now to FIGS. 2 through 6, the operation of one system according to the invention is depicted by reference to a series of screen shots illustrating how one embodiment of the system may operate. As can be seen from the figures, and as will be clarified by the following description, the embodiment being described includes a web-based system that includes a server, such as the server 12 depicted in FIG. 1, operating an HTTP server that allows HTTP clients to access information from the server 12. In this embodiment, the information accessed from the server 12 can include HTML pages that can be viewed by the user on his or her client system.

In embodiments wherein the client station includes a mobile phone, the system 10 may include a server that supports exchange of information with the kind of client software configured to execute on a mobile phone. To this end, the server 12 may include a WAP (wireless application protocol) server that will communicate information in a format suitable for viewing and interacting with on a mobile phone device.

In other embodiments, the client may include a wireless email device, and the server 12 may include server functionality necessary for exchanging information with the wireless email device; the exchange is in a format usable by a client executing on the device, and the information is in a format viewable by a user operating the wireless device and amenable to the user's interacting with the server 12. Accordingly, it will be understood to those of ordinary skill in art that the systems and methods described herein are extendable and adaptable, and may be modified to meet the needs of the application at hand, including being modified to service different kinds of client stations, to scale the system (for example by expanding or shrinking the number of client stations on the network), and to add security features such as digital certificates and authentication protocols (such as Kerberos).

Turning to FIG. 2, there is depicted one screen shot of an application according to the invention. As shown in this screen shot, the front end (user interface) of the system 10 is a contact manager providing information on how to contact a user or group of users by phone. In other embodiments, the contact manager may provide other kinds of information, such as one or more email addresses, residential addresses, pager numbers, or other information representative of a way to contact a user.

Accordingly, in a first step of operation, when an individual (typically a client) contacts the enterprise, an administrator handling the contact event (for example, a telephone call) can activate the contact manager program application to retrieve contact information about the respective initiator of the contact event (for example, the caller). This information is then presented to the administrator for his or her use.

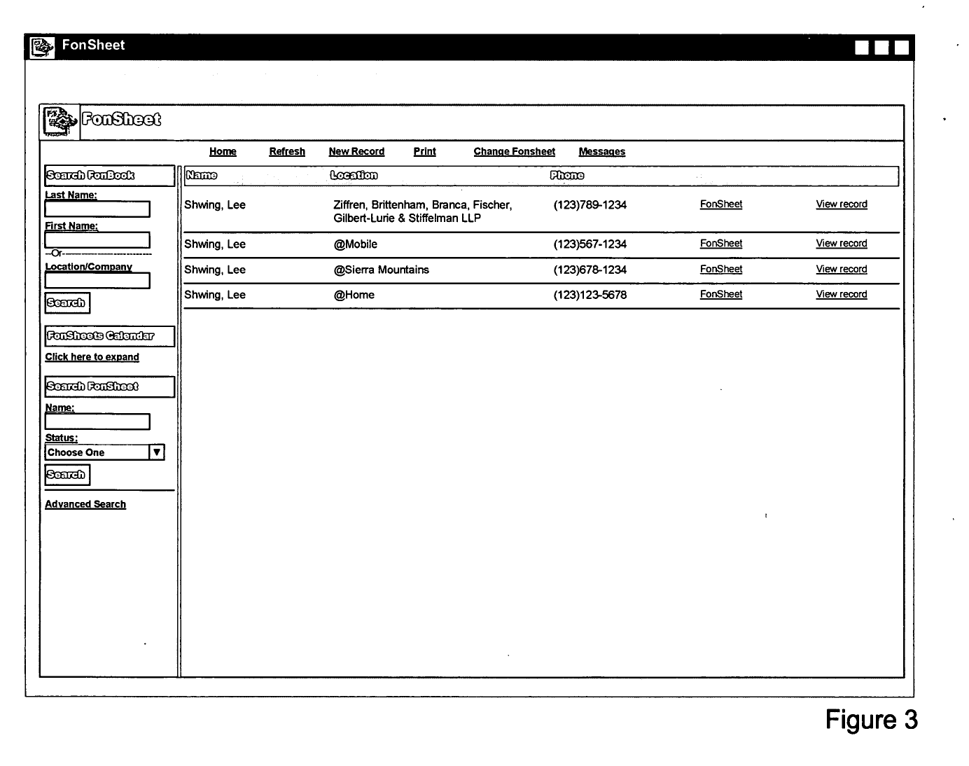

FIG. 3 depicts another screen shot illustrating the situation wherein a user has a plurality of contact addresses. In this case, each address is presented in the user interface of the contact manager, and a hypertext link is provided in-line with the respective contact address. A hypertext link “FonSheet” is depicted in-line with each contact address shown in FIG. 3; the FonSheet link is to the contact event management and control application.

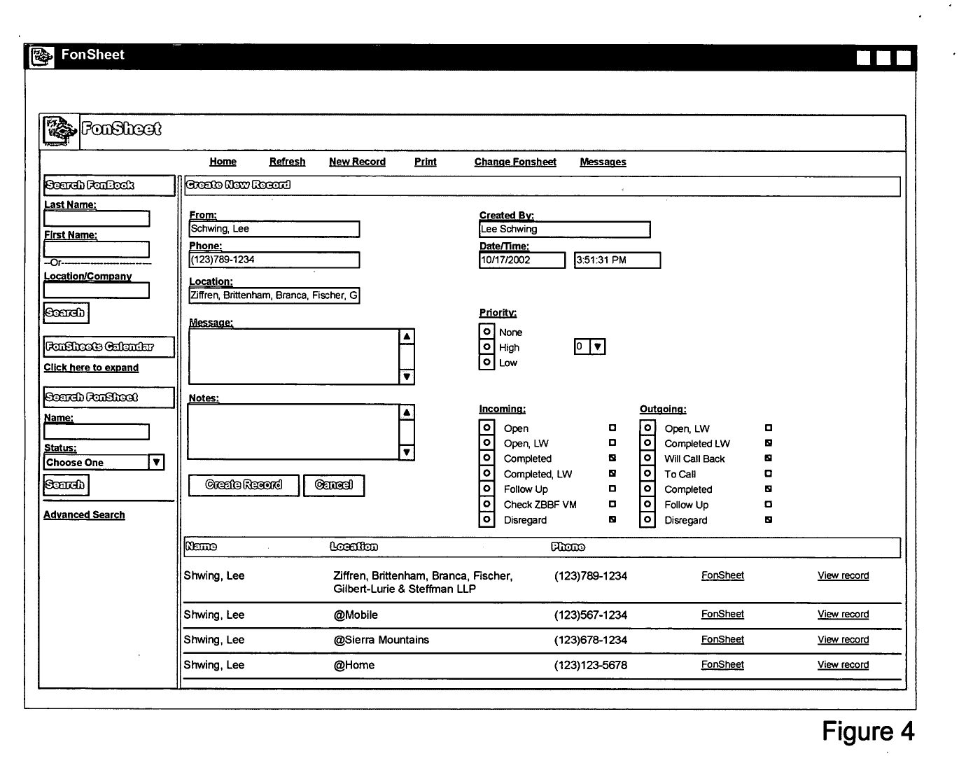

FIG. 4 depicts the user interface presented to a user upon activating the FonSheet hypertext link. As shown in FIG. 4 a new record file can be presented to the user. Through this new record interface the user can input the necessary information to log the contact event. As shown in FIG. 4, the depicted user interface allows the user to indicate the party initiating the contact, the time of the contact event, the priority of the contact event, whether it is an incoming or an outgoing contact event, and the status of the call, such as whether it is open, completed, requires follow-up, or may be disregarded.

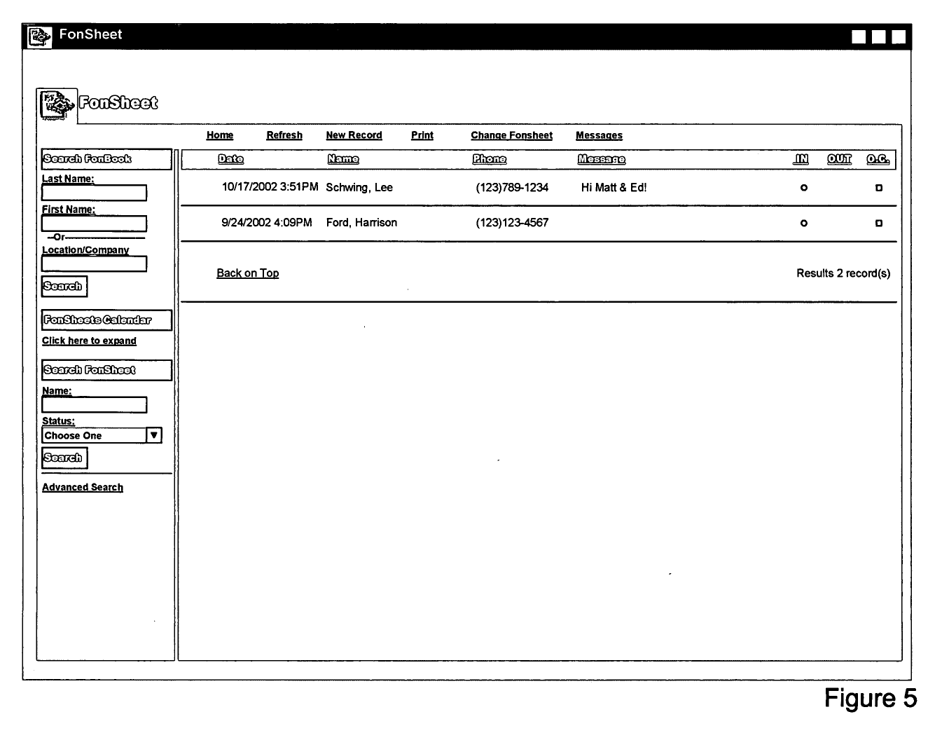

Turning to FIG. 5, a user interface is depicted that shows the user interface presented to a user once the information about a call has been entered into the contact event management and control application. As shown in FIG. 5, a message flag may be inserted in-line with the contact address, to indicate that a message from that party has arrived.

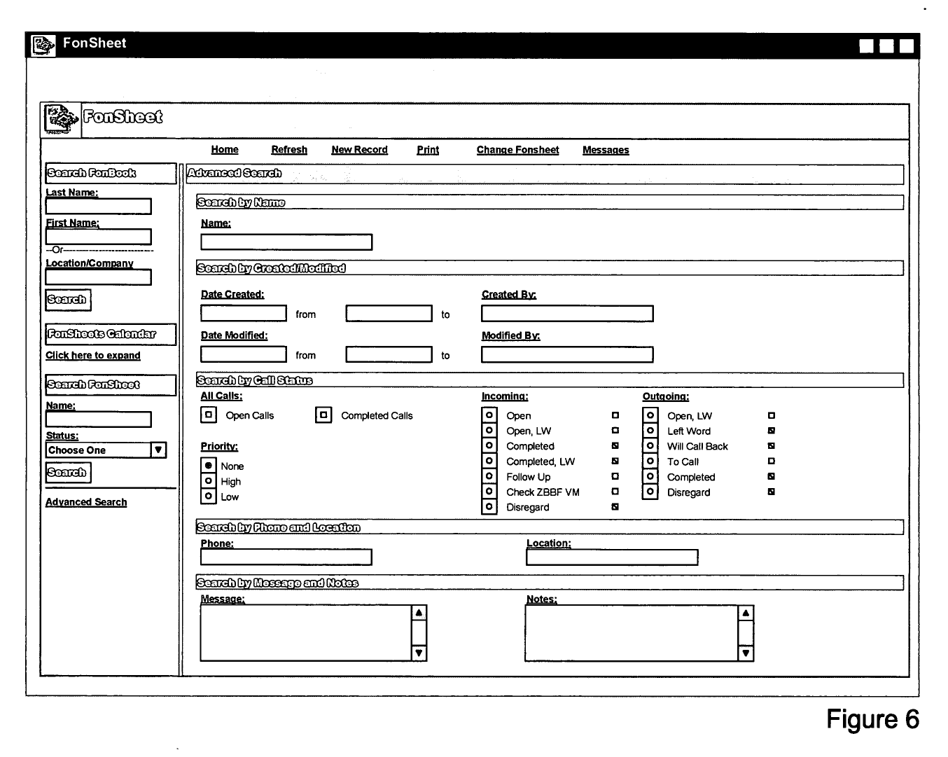

FIG. 6 depicts a search screen interface that allows a user to determine the status of his or her contact event list. For example, FIG. 6 depicts a user interface wherein the user is capable of searching, by call status, to determine whether there exists an open call having a designated priority. Thus, the user may search open contact events having a high or low priority, for example. Additionally, FIG. 6 depicts an embodiment wherein the status of the incoming call also may be employed in a search strategy. For example, the user may choose to search open incoming contact events requiring follow-up.

Additionally, the user interface of FIG. 6 shows that there are other ways of searching the contact event information managed by the database 22. For example, the user may search by name to determine whether a specific party has called and deposited a message. Additionally, the user may search by date created or date modified to identify whether any part of his or her contact information has changed (indicating a contact event) within a designated interval of time.

FIG. 6 further shows that additional options are available to the user, such as the ability to search by phone number and location, as well as the ability to search by messages and notes.

Accordingly, FIGS. 2 through 6 depict an operation for one embodiment of the invention; the figures illustrate a process for managing a contact event and systems allowing a user to understand the status of a contact event and to respond appropriately.

The system 10 depicted in FIG. 1 includes a data processing platform 12 supporting a server application implementing the systems and methods described herein, managing and controlling contact events. In one embodiment, the server system includes a database server, such as a Microsoft SQL Server. The database server executes on the platform 12 and provides network-based support for the contact event management and control application. Additionally, the data processor 12 can include a web server that interfaces to the database server 22 to provide the contact event management and control system as a web service that may be accessed by a user on the network, such as a user operating a client station 14, 16 or 18.

Although FIG. 1 graphically depicts the contact event system 10 as a collection of functional block elements, it will be apparent to one of ordinary skill in the art that these elements can be realized as computer programs or portions of computer programs capable of executing on the data processor platform 12, and configuring the data processor 12 to act as a system according to the invention.

The contact event system 10 can be realized as a software component operating on a conventional data processing system, such as a UNIX workstation. In this embodiment, the contact event management and control system can be implemented as a C language computer program, or a computer program written in any high-level language such as C++, Fortran, Java, or Basic.

Additionally, in an embodiment wherein microcontrollers or DSP (digital signal processing) hardware components are employed, the system can be realized as a computer program written in microcode—or written in a high-level language that is compiled down to microcode—executable on the hardware platform employed. The development of such programs is known to those of ordinary skill in the art, and such techniques are set forth in the literature, including for example, in Programming in C, by Stephen G. Kochan, (Sams, 1983).

Those skilled in the art will know or be able to ascertain, using no more than routine experimentation, many equivalents to the embodiments and practices described herein. For example, in those embodiments where the client station may comprise a mobile or other wireless communication device, the device may run the client-side application for the contact event management and control application, and integrate with the client station to allow for computer-controlled telephony applications, such as automatic dialing, e-mailing, and paging.

In one such embodiment, the client may be a Microsoft® Windows® Powered SmartPhone, the Nokia 7650 phone, the Nokia 9200 phone, or any other phone or device that combines mobile voice and data communications with a system that supports personal information management software. In this case, the client-side portion of the contact event management and control application may be a SmartPhone application integrating telephony functionality with data management applications. The SmartPhone platform provides voice and text communication supports wireless data applications. The SmartPhone executes the Microsoft® Windows CE, a real-time operating system for embedded systems. The client-side application could comprise a resident or a downloadable software or firmware application capable of executing on the Windows CE operating system and capable of controlling the telephony functions of the SmartPhone. Alternatively, the phone may be combined with server-side text-to-speech and/or IVR technology to allow for audio reading of a contact record, voice-activated return dialing, voice-updating of the record, or any combination of these.

In an embodiment wherein the client is a PDA having mobile phone capabilities, such as the Handspring Treo or the Microsoft SmartPhone, or wherein a PDA can communicate to a mobile phone either through a wire or wirelessly utilizing Bluetooth, 802.11 or another local wireless technology, the client can provide user functionality not found on other client platforms, i.e., a Windows-based PC or a web-centric client. In this embodiment, if the user invokes these functions intrinsic to the Handspring Treo or the Microsoft SmartPhone, or other device those actions can be tracked and used to create or modify call records in the application. An example would be if a person were to use the proprietary phone directory inside Microsoft SmartPhone to initiate a call. The client-side application, as described, would create a call record with all pertinent data; the call record would then be reconciled with all of the appropriate application data sets within the enterprise.

The method described above holds for any client software or firmware application executing on a telephony-enabled client station. In one embodiment, a client that is Windows- or Linux-based, executing on Intel hardware, for example, may be operating on a network using a Voice-Over-IP (internet protocol) technology. In this embodiment where the client station is also the “phone”, as the client receives or initiates a call (regardless of whether the call transaction is conducted directly through the application, through another process executing on the client station, or through an IVR-enabled or other server), the application will automatically create or modify call records.

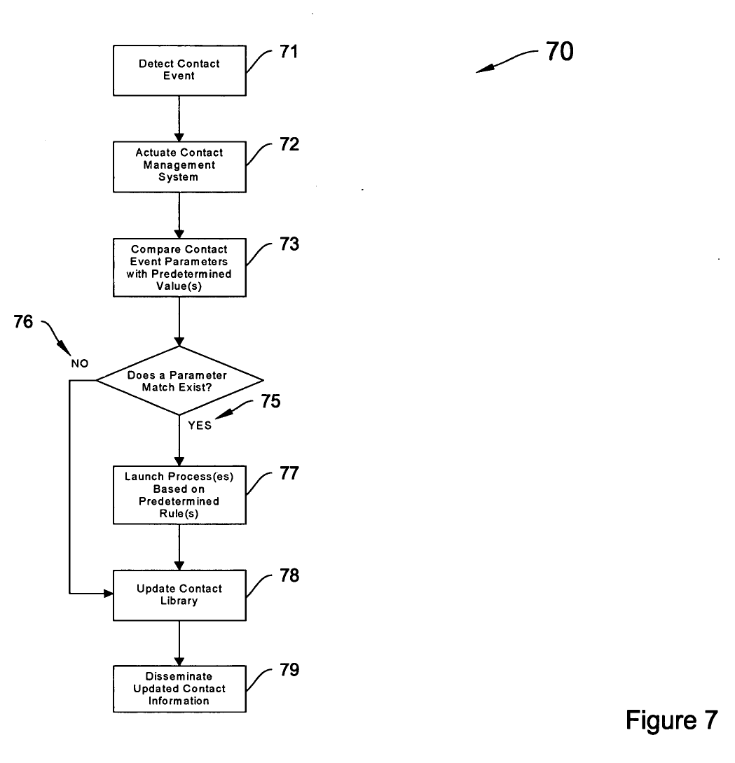

FIG. 7 is a flowchart depiction of an embodiment of the contact management system 70 according to the invention. The method includes detecting a contact event 71. Once a contact event is detected, such as when a telephone call is received, a contact management system is actuated 72. Parameters associated with the contact event (such as name, priority, subject matter, or any set of flags and codes that may resemble a paper-based phone log system) are then compared 73 with a set of predetermined values (set for detecting or responding to important contact events). If a match exists 75, then, in response to the contact event, a number of processes are spawned 77, based on a set of at least one predetermined rule. Subsequently, the contact library is updated 78 with the new contact event information as well as with any result associated with the process or processes launched 77 in response to the contact event. If no match is detected between the parameter or parameters associated with the contact event and the predetermined values, then the contact library is simply updated 78 without any need for launching a process 77 based on predetermined rule(s). Thus, in the case of no parameter match, the contact library is simply updated 78. In the embodiment depicted by FIG. 7, updated contact information is then disseminated across the enterprise, as appropriate.

The contact management system has control over a primary contact library (not shown in FIG. 7), a main depository of contact information associated with the enterprise. In one embodiment, the contact management system retrieves information associated with the contact event from the contact library (not shown). If new information is detected in the contact event, then the contact library is updated based on the new information, and subsequently disseminated across the enterprise.

Accordingly, it will be understood that the invention is not to be limited to the embodiments disclosed herein, but is to be understood from the following claims, which are to be interpreted as broadly as allowed under the law.

We claim:

1. A method of managing contact events across an enterprise, comprising:
a. in response to a contact event, actuating a contact management system having control over a primary contact library;
b. under control of the contact management system, retrieving information associated with the contact event from the primary contact library;
c. if new information is associated with the contact event, updating, based on the new information and under the control of the contact management system, the information associated with the contact event in the primary contact library; and
d. disseminating, to at least a portion of the enterprise, the updated information associated with the contact event.

2. The method of claim 1, further comprising processing the contact event according to at least one predetermined rule.

3. The method of claim 2, wherein the processing comprises executing at least one command in response to the contact event.

4. The method of claim 3, wherein the at least one command belongs to the group consisting of: responding to the contact event, assigning the contact event to at least one user associated with the enterprise, spawning at least one process within a system belonging to the enterprise, launching at least one server-based process, and a combination thereof.

5. The method of claim 1, wherein the contact event belongs to the group consisting of: a telephone call, a fax transmission, a pager message, an electronic text message, a still image communication, a video communication, an audio communication, a voice communication, an office visit, a paper-based communication, and any combination thereof.

6. The method of claim 1, wherein the information associated with the contact event is uniquely identifiable by an associated plurality of parameters.

7. The method of claim 6, wherein the associated plurality of parameters comprise text, at least one flag, at least one code, or a predetermined combination thereof.

8. The method of claim 1, wherein the disseminating is performed according to a method belonging to the group consisting of: real-time updating, updating based on a predetermined schedule, updating based on a random schedule, on-demand updating, updating based on feasibility, and a combination thereof.

9. The method of claim 1, wherein the contact management system comprises:
a. a primary server;
b. at least one client station capable of interacting with the primary server to exchange information; and
c. a primary contact manager software application executing on the primary server and capable of managing the primary contact library.

10. The method of claim 9, wherein the primary server and each of the at least one client station can operatively interact according to a communication mode selected from the group consisting of: wired, wireless, and a combination thereof.

11. The method of claim 9, wherein each of the at least one client station can operatively interact with the primary server across a network selected from the group consisting of: a local-area network (LAN), a wide-area network (WAN), a virtual private network (VPN), a cellular network, a wireless network, a wired network, the internet, an intranet, and a combination thereof.

12. The method of claim 9, wherein the primary server can operatively interact with a user to exchange information.

13. The method of claim 12, wherein the primary contact manager provides a user interface to enable the user to interact with the primary server and exchange information.

14. The method of claim 13, wherein the user interface provides information about how to contact an entity, the information including at least one item selected from the group consisting of: telephone number, electronic mail address, office address, pager number, office address, fax number, any information representative of a means to contact an entity, and a combination thereof.

15. The method of claim 13, wherein the user interface comprises:
a. a display panel; and
b. a plurality of virtual menu panels arranged, according a predetermined order, on the display panel.

16. The method of claim 15, further allowing the user to customize the predetermined order of the virtual menu panels on the display panel.

17. The method of claim 15, furthering allowing the user to actuate at least one of the virtual menu panels.

18. The method of claim 15, wherein each of the virtual menu panels is functionally associated with at least one aspect of managing contact information.

19. The method of claim 13, wherein the primary contact manager allows the user to input security information, upon which input of the security information the primary server defines the scope of the user's access authorization.

20. The method of claim 19, wherein the scope includes viewing contact information.

21. The method of claim 20, wherein the scope includes managing contact information.

22. The method of claim 9, wherein the contact management system comprises a plurality of client stations.

23. The method of claim 13, wherein at least one of the plurality of client stations can operatively interact with at least one other of the plurality of client stations to exchange information.

24. The method of claim 23, wherein at least one of the plurality of client stations can operatively interact with at least one other of the plurality of client stations according to a communication mode selected from the group consisting of: wired, wireless, and a combination thereof.

25. The method of claim 23, wherein at least one of the plurality of client stations can operatively interact with at least one other of the plurality of client stations across a network selected from the group consisting of: a local-area network (LAN), a wide-area network (WAN), a virtual private network (VPN), a cellular network, a wireless network, a wired network, the internet, an intranet, and a combination thereof.

26. The method of claim 9, wherein each of the at least one client station is selected from the group consisting of: a personal computer, a personal digital assistant (PDA), a tablet computer, a handheld computing device, a wireless telephone, a wireless paging device, a wireless communication device, a notebook computer (laptop), a network-ready stationary data management device, a network-ready mobile data-management, and a combination thereof.

27. The method of claim 9, wherein at least one of the at least one client station can operatively interact with a user to exchange information.

28. The method of claim 9, wherein at least one of the at least one client station includes a client server.

29. The method of claim 28, wherein a client contact manager executes as a software application on the client server.

30. The method of claim 29, wherein the client contact manager controls a client-side contact library.

31. The method of claim 30, wherein the client contact manager can integrate with the primary contact manager and operatively interact with the primary contact manager to exchange information.

32. The method of claim 31, wherein the primary contact manager and the client contact manager reconcile information contained in the primary contact library with the associated information contained in the client contact library.

33. The method of claim 32, wherein the client user interface provides information about how to contact an entity, the information including at least one item selected from the group consisting of: telephone number, electronic mail address, office address, pager number, office address, fax number, any information representative of a means to contact an entity, and a combination thereof.

34. The method of claim 32, wherein the client contact manager provides a client user interface to enable the user to interact with the client server.

35. The method of claim 34, wherein the client user interface comprises:
a. a client display panel; and
b. a plurality of client virtual menu panels arranged, according a predetermined order, on the client display panel.

36. The method of claim 34, wherein client user interface comprises an audio interface selected from the group consisting of: a microphone, a speaker, and a combination thereof.

37. The method of claim 35, further allowing the user to customize the predetermined order of the client virtual menu panels on the client display panel.

38. The method of claim 35, furthering allowing the user to actuate at least one of the client virtual menu panels.

39. The method of claim 35, wherein each of the client virtual menu panels is functionally associated with at least one aspect of managing contact information.

40. The method of claim 35, wherein the client user interface serves as a front-end interface to the primary contact manager.

41. The method of claim 40, wherein the client user interface enables the user to access the primary contact library.

42. The method of claim 41, wherein client user interface enables the user to manipulate the primary contact library.

43. The method of claim 27, wherein the client contact manager allows the user to input security information, upon which input of the security information the client server defines the scope of the user's access authorization.

44. The method of claim 43, wherein the contact management system provides security and user authentication by features belonging to the group consisting of: digital certificates, Secure Socket Layer, secure shell (SSH), Kerberos authentication, any comparable method for enforcing user authentication and connection security, and a combination thereof.

45. The method of claim 43, wherein the scope includes viewing contact information.

46. The method of claim 43, wherein the scope includes managing of contact information.

47. The method of claim 46, wherein the managing of contact information includes at least one of the group consisting of: viewing contact information, deleting contact information, updating contact information, creating contact information, responding to a contact event, initiating a contact event, and a combination thereof.

48. The method of claim 39, wherein at least one of the client virtual menu panels is equipped with a single-step actuation that prompts the client contact manager to initiate a contact event.

49. The method of claim 36, wherein the client user interface allows the user to voice-actuate the client contact manager to initiate a contact event.

50. The method of claim 9, wherein the primary server supports at least one network functionality, each of the at least one network functionality belonging to the group consisting of: a web server, an FTP server, a Gopher server, a network server, and a combination thereof.

51. The method of claim 9, wherein each of the at least one client station is equipped with a network software client.

52. The method of claim 51, wherein the network software client comprises a world-wide web client.

53. The method of claim 52, wherein the web client supports the wireless application protocol (WAP).

54. The method of claim 52, wherein the web client supports handling server-side scripts, handling client-side scripts, integration with a database server, providing visual design tools, providing wizards and templates to perform tasks comprising generating system query language (SQL) calls to the database, or any combination thereof.

55. The method of claim 52, wherein the world-wide web client comprises a web browser.

56. The method of claim 51, wherein the network software client can operatively interact with a server belonging to the group consisting of: a web server, an FTP server, a Gopher server, a network server, and a combination thereof.

57. The system of claim 9, wherein the primary contact manager categorizes contact information in the primary contact library into a plurality of contact lists.

58. The method of claim 57, wherein each of the contact lists belongs to the group consisting of: an enterprise contact list containing contact information for at least a portion of the enterprise, and an individual contact list containing contact information for at least one individual associated with the enterprise.

59. The method of claim 13 and claim 57, wherein the primary contact manager provides for viewing customization of each of the contact lists, according to the preference set of each of the at least one user.

60. The method of claim 59, wherein the viewing customization is according to a filtering of parameters associated with the respective one of the contact lists, by which filtering the user determines desired features of the respective one of the contact lists to view.

61. The method of claim 59, wherein the viewing customization is according to a sorting of contact information in the respective one of the contact lists, the sorting being according to parameters associated with the respective one of the contact lists.

62. The method of claim 59, wherein the viewing customization is according to a search of the primary contact library based on at least one criterion associated with contact information contained in the primary contact library.

63. The method of claim 60, claim 61, or claim 62, wherein each of at least one criterion belongs to the group consisting of: status, priority, date created, date modified, name, text, code, flag, priority, e-mail address, telephone number, fax number, address, and a combination thereof.

64. The method of claim 63, wherein the primary contact manager monitors the primary contact library according to a predetermined subset of at least one of the parameters.

65. The method of claim 64, further including executing at least one command, if there is a match to the predetermined subset of the at least one of the parameters.

66. The method of claim 62, wherein at least one command involves manipulating the primary contact library.

67. The method of claim 9, wherein the contact management system further supports scalability by allowing for variation in the number of client stations that it integrates.

68. The method of claim 30, wherein the contact management system further supports a client-side functionality belonging to the group consisting of: client-side computer-controlled telephony application, downloading and installing of a client-side software application onto the client server, allowing for integration of the client station into any combination of primary or client server-side text-to-speech or interactive voice response technology to allow for audio reading of records and/or voice-activated response to, or updating of, the primary or client-side contact library.

69. The method of claim 68, wherein the computer-controlled telephony application belongs to the group consisting of: dialing, e-mailing, paging, and a combination thereof.
